(19) United States
(12) Patent Application Publication
(10) Pub. No.: US 2004/0216240 A1
(43) Pub. Date: Nov. 4, 2004

(54) Stapler

(76) Inventors: Jeffrey A. Kramer, Miami Beach, FL (US); William W. Rosenfeld, Davie, FL (US)

Correspondence Address: MALLOY & MALLOY, P.A., Historic Coral Way, 2800 S.W. Third Avenue, Miami, FL, 33129, US

(21) Appl. No.: 10/768,961

(22) Filed: Jan. 30, 2004

Related U.S. Application Data
(63) Continuation-in-part of application No. 29/189,012, filed on Aug. 26, 2003.
Application No. 29/189,012 is a continuation-in-part of application No. 29/151,864, filed on Dec. 11, 2001, now Pat. No. D478797.

(51) Int. Cl. B26B 11/00

(52) U.S. Cl. 7/158

(57) ABSTRACT

An improved stapler having a pair of stapler arms pivotally secured in confronting relation with one another, a first of the arms containing a plurality of staples and structured to dispense one of the staples towards the other arm upon being pivotally moved towards the other arm and meeting resistance. An opener segment is further provided and extends along a length of one of the arms, the opener segment including a proximal end and a distal end, with the proximal end secured to the arm. A blade is disposed between the opener segment the arm to which it is secured, at generally the proximal end of the opener segment which tapers towards its distal end so that the distal end can be introduced into a fold defined by a closure flap of an envelope until the envelope engages the blade and is cut thereby to open it.

### CLAIM OF PRIORITY

The present application is a “continuation-in-part” patent application of previously filed, now pending design patent application having Ser. No. 29/189,012 filed on Aug. 26, 2003, which is a continuation-in-part design patent application of previously filed, having Ser. No. 29/151,864 filed on Dec. 11, 2001, which issued into U.S. Design Pat. No. D478,797 on Aug. 26, 2003, also incorporated herein by reference.

### BACKGROUND OF THE INVENTION

1. Field of the Invention

The present invention relates to an improved stapler that is preferably compact and highly manipulable, and in addition to providing for facilitated use in order to staple a plurality of articles with one another also conveniently includes structure to significantly facilitate the opening of envelopes and/or packages. In that way, a user tasked with opening a large number of envelopes and/or packages can quickly and easily open those articles and conveniently and without interruption to manipulate an additional device, is able to effectively staple documents and/or articles to one another, such as stapling the envelope to a correspondence contained therein for organization after disbursement and during review of the articles received.

2. Description of the Related Art

Staplers are very popular, commonly utilized office tools employed numerous times on almost a daily business by many individuals. Naturally, a primary source of utilization for staplers is in the stapling of a variety of documents with one another so as to prevent the loss or misplacing of one or more articles which relate with one another. Moreover, due to the popularity of staplers, many different shapes, styles and sizes of staplers have been developed, ranging from large multi-document staplers to compact mini-staplers. All of these staplers, however, have the same basic and limited, albeit very useful, functionality of passing the prongs of a staple through one or more sheets, and binding them together by bending and/or looping the prongs.

In addition to staplers, another important office product that has been developed over the years in a variety of different styles and configurations is the letter opener. In particular, letter openers have been developed and utilized so as to facilitate the quick and rapid opening of envelopes and/or packages for appropriate sorting and/or review of the contents of these documents. Typically, however, the use of a letter opener so as to open and subsequently organize and/or review documents contained within an envelope is a singular task that requires a substantially amount of follow up. For example, a person tasked with opening hundreds of envelopes may very well go through the opening of the envelopes very quickly and perform an initial degree of sorting of the documents contained therein, however, they are generally forced to utilize a rudimentary stacking system if they wish to proceed through the envelope opening at a generally rapid pace. Of course, it is recognized that it would be preferable if the envelope and/or package opening process could be effectively associated with an increased form of organization, such as stapling documents with one another and/or stapling an envelope with its contents at the time of opening and/or sorting. In this manner, disruption of the stacks will not lead to a loss of documents or the need to later perform an additional time consuming task. Of course, utilizing traditional office equipment, such techniques can be cumbersome and do not permit a free flowing and/or rapid pace to be exhibited if both tasks are to be performed. As a result, it would be highly beneficial to provide an improved stapler which is effectively equipped with structure to facilitate the opening of envelopes and/or packages in a manner that does not interfere with the normal use and/or operation of the stapler, but which also allows for convenient and effective letter opening utilization. Further, such an improved stapler should be effectively configured so as to minimize the need for awkward manipulation and/or repositioning of the device within the hands of the user, thereby permitting extensive continued use.

Additionally, unlike prior art devices which incorporate a letter opener with other office equipment such as a staple remover, the novel and convenient integration of letter opening capabilities with an improved stapler is effective and symbiotic towards a primary and demanding task associated with the use of this equipment. Indeed, the present invention recognizes the need for more than merely a device which combines multiple functionalities, but rather for an improved stapler that effectively increases the functionality of a stapler in a novel fashion that maximizes the beneficial utilization of all functional components of a device during repeated, generally contemporaneous utilization of all of the different functionalities.

### SUMMARY OF THE INVENTION

The present invention relates to an improved stapler. In particular, the improved stapler includes a pair of arms that are pivotally secured in confronting relation with one another in a manner similar to that of a traditional stapler. Specifically, one of the arms contains a plurality of staples and thereby is configured to dispense one of the staples towards the other arm when it is pivotally moved towards that other arm and meets resistance.

Further provided with the improved stapler of the present invention is an opener segment. In particular, the opener segment extends along at least a portion of at least one of the arms. Also, the opener segment includes a proximal end and a distal end, the proximal end being secured to one of those arms. Moreover, disposed between the opener segment and the arm is a blade. The blade is disposed at generally the proximal end of the opener segment such that when an at least partially tapered distal end of the opener segment is introduced at a fold made by a closure flap of an envelope, the opener segment may be pushed sufficiently into the envelope until the blade engages the envelope and cuts it, facilitating the opening of the envelope and removal of it's contents. This removal can then be followed by immediate stapling of the contents with one another and/or with the envelope in which they were contained.

These and other features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective illustration of the improved stapler of the present invention in operative use to open an envelope;

FIG. 2 is a side view of the improved stapler of the present invention; and

FIG. 3 is a bottom view of the improved stapler of the present invention.

Like reference numerals refer to like parts throughout the several views of the drawings.

### DETAILED DESCRIPTION OF THE PREFERRED EMBODIMENT

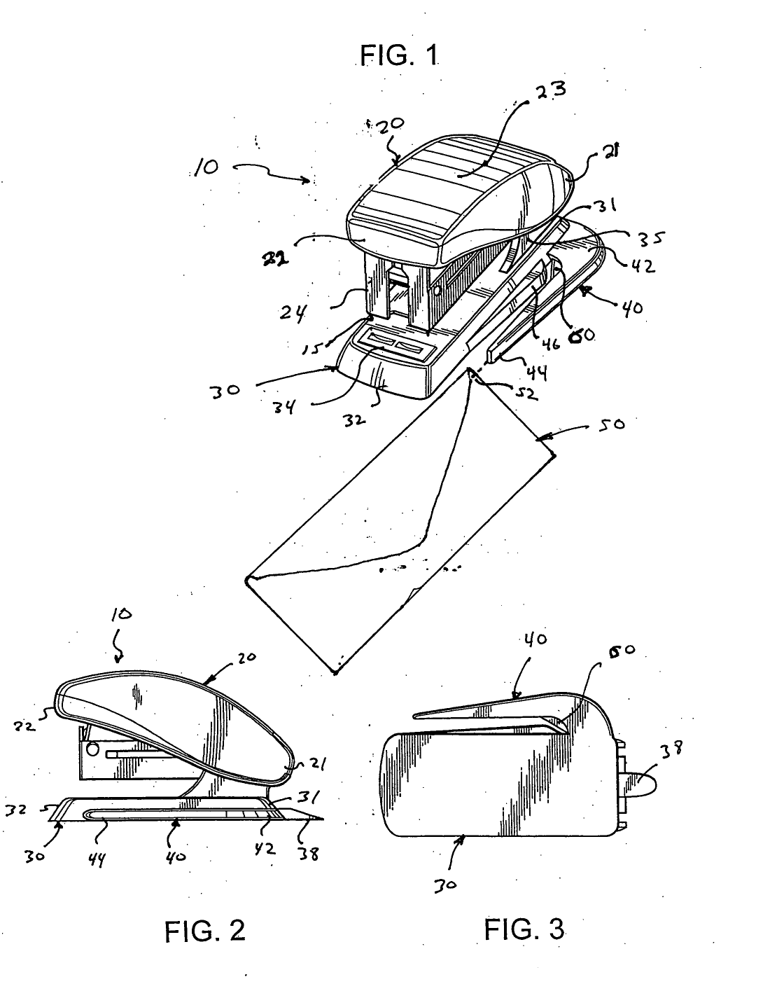

The present invention is directed towards an improved stapler, generally indicated as 10. In particular, the improved stapler preferably includes a pair of arms 20 and 30, preferably stapler arms, pivotally secured with one another in confronting relation. Specifically, as illustrated in FIG. 1, each of the arms 20 and 30 preferably includes a first end 21 and 31, respectively, and a second end 22 and 32, respectively. In the illustrated embodiment, the arms 20 and 30 are pivotally secured with one another generally at their respective first ends 21 and 31 thereof so that the second ends 22 and 32 may move towards and away from one another. Looking further to the preferred, illustrated embodiment, a first arm 20 may be defined as an upper arm which contains and dispenses staples 15 for use to secure a multitude of articles with one another. As such, in this preferred embodiment, the first arm 20 may include a cover segment 23 which is pushed down by a user, and a carrier element 24. The carrier element 24 is preferably configured to hold a large, aligned number of staples 15 therein in a conventional manner so that they may be dispensed one at a time via an opening defined generally at the second end 22 of the first arm 20. In this regard, a plunger or other type element as is typically found within a stapler may be positioned so as to dispense the staples 15 upon pushing down of the cover element 23. Moreover, the cover element 23 is preferably configured to pivot independent from the carrier element 24 so as to expose an interior of the carrier element 24 for loading of the staples. Conversely, the second arm 30 in the illustrated embodiment preferably defines an abutment against which resistance is met during downward or compressing pushing of the first arm 20, so as to achieve dispensing of a staple 15 in a conventional fashion. Along these lines, a mold plate 34 may be provided in the second arm 32 so as to effectively achieve appropriate curling and/or binding of the staples 15 as desired.

Although the fist and second arms 20 and 30 may generally overlap at their respective first ends 21 and 31 so as to achieve the relative pivotal positioning required for dispensing, in a preferred, illustrated embodiment, the second arm 30 may include one or more upwardly depending pivot posts 35 at which the first arm 20 is pivotally secured. Regardless of the manner of pivotal securement, however, one or more articles which are to be stapled with one another are preferably disposed between the confronting second ends 22 and 32 of the first and second arms 20 and 30 such that pushing of the arms 20 & 30 towards one another will result in the passage of the staple 15 through the articles and the fastening of those articles with one another.

Extending from preferably one of the arms 20 or 30 is an opener segment 40. In particular, the opener segment 40 is structured to facilitate the opening of an envelope 50 or package. In the preferred, illustrated embodiment, the opener segment 40 is secured to the second arm 30 and may be generally co-planar there with, such as along a bottom surface. Of course, a more staggered alignment is also possible. Looking in detail to the opener segment 40, it preferably includes a proximal end 42 and a distal end 44. Preferably, the proximal end 42 will be secured to and can be integrally formed with the second arm 30. Moreover, the opener segment 40 preferably extends along at least a portion of a length of the second arm 30, as seen in the figures, in generally parallel relation thereto. In order to facilitate an effective introduction of the distal end 44 of the opener segment 40 into at least a fold 52 defined by a closure flap of an envelope 50, the opener segment 40 preferably has a generally tapering configuration towards the distal end 44. In this regard, the distal end 44 may be said to generally define a point, and will generally be spaced from the second arm 30 so as to further facilitate the slided passage of the opener segment 40 in an opening manner within the fold 52 of an envelope 50.

Disposed between the opener segment 40 and the second arm 30 is a blade 60. In particular, the blade 60 is preferably angled towards the distal end 44 of the opener segment as seen in the figures. Additionally, although the blade 60 may be connected to both the opener segment 40 and the second arm 30, it may be preferred that the blade 60 be at least partially embedded and thereby secured within the opener segment 40, with an appropriate cutting edge portion exposed. During use, it is the blade 60 that ultimately engages the envelope 50 and causes a cutting and therefore opening of the envelope 50. Also, turning to FIG. 1, although in many embodiments it may be sufficient for a perimeter of the second arm 30 to confront an interior of the opener segment 40, a guide ridge 46 may also be provided so as to effectively guide an article to be opened onto the blade 60 and further facilitate opening. This guide ridge 56 may also be secured and/or integrally formed with the second arm 30.

It is also recognized that the distal end 44 of the opener segment 40 preferably is directed towards the second end 32 of the second arm 30 in a manner whereby the opener segment can be said to be generally parallel with the second arm 30. Further, by directing the distal end 44 towards the second end 32 of the second arm 30, substantially increased convenience for utilization can be achieved, as a user need not reorient or re-manipulate the improved stapler 10 within their hand in order to achieve both opening functionality and subsequent stapling functionality. As can be appreciated this can achieve a significant time savings and increase the smooth and continuous utilization by a user tasked with the job of opening a large number of envelopes and securing their contents to one another and/or to the envelopes 50 from which they were withdrawn.

Finally, turning to FIGS. 2 and 3 it is also seen that a wedge element 38 may also protrude from one of the arms, and preferably the second arm 30. In the illustrated embodiment this wedge element 38 protrudes from the first end 31 of the second arm 30 and includes a generally narrow and/or pointed configuration. As a result, this wedge element 38 may be utilized so as to remove and/or pry-off a staple 15 from an article. In particular, in use the wedge element 38 is slid under the staple 15 and a degree of leverage is applied so as to open the clasping ends of the staple 15 and facilitate the removal thereof. Accordingly, if a staple is introduced into one or more articles utilizing the present improved stapler 10, yet that stapling is in error or must otherwise be undone, a rapid and convenient means for removing the staple 15 is conveniently present.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. An improved stapler comprising:
a pair of arms pivotally secured in confronting relation with one another;
one of said arms containing a plurality of staples and structured to dispense one of said staples towards said other arm upon being pivotally moved towards said other arm and meeting resistance;
a opener segment extending along at least a portion of a length of one of said arms, said opener segment including a proximal end and a distal end, said proximal end secured to said one of said arms;
a blade disposed between said opener segment said arm to which it is secured, at generally said proximal end of said opener segment; and
said opener segment at least partially tapering towards said distal end, said distal end being structured to be introduced at least at a fold defined by a closure flap of an envelope until the envelope engages said blade and is cut thereby.

2. An improved stapler as recited in claim 1 wherein said blade is angled towards said distal end.

3. An improved stapler as recited in claim 1 wherein said distal end defines a point.

4. An improved stapler as recited in claim 1 wherein a bottom of said opener segment is generally co-planer with a bottom of said arm to which it is secured.

5. An improved stapler as recited in claim 1 wherein said opener segment is generally co-planer with said arm to which it is secured.

6. An improved stapler as recited in claim 1 wherein said arms include first ends pivotally secured to one another, and second ends which move toward and away from one another as a result of said pivotal securing at said first ends.

7. An improved stapler as recited in claim 6 wherein said proximal end of said opener segment is secured generally at said first end of one of said arms.

8. An improved stapler as recited in claim 7 wherein said distal end of said opener segment extends towards said second end of one of said arms.

9. An improved stapler as recited in claim 1 wherein said arms include a first arm structured to contain and dispense said staples, and a second arm against which said staples are dispensed.

10. An improved stapler as recited in claim 9 wherein said opener segment is secured to said second arm.

11. An improved stapler as recited in claim 10 wherein said second arm includes a first end pivotally secured to said first arm, and a second end at which engages a dispensed staple.

12. An improved stapler as recited in claim 11 wherein said proximal end of said opener segment is secured generally at said first end of one of said second arm.

13. An improved stapler as recited in claim 12 wherein said distal end of said opener segment extends towards said second end of said second arm.

14. An improved stapler as recited in claim 12 wherein said blade is angled towards said distal end.

15. An improved stapler as recited in claim 12 wherein said distal end defines a point.

16. An improved stapler as recited in claim 10 wherein a bottom of said opener segment is generally co-planer with a bottom of said second arm.

17. An improved stapler as recited in claim 10 wherein said opener segment is generally co-planer with said second arm.

18. An improved stapler as recited in claim 10 wherein said second arm includes a compartment structured to contain extra staples.

19. An improved stapler as recited in claim 10 further comprising a wedge element extending from said first end of said second arm and structured to be introduced within a secured staple so as to facilitate removal thereof.

20. An improved stapler as recited in claim 1 wherein said opener segment and said arm to which it is secured are integrally formed with one another.

21. An improved stapler comprising:
a pair of stapler arms pivotally secured in confronting relation with one another and structured to pass a staple through an item positioned therebetween;
a opener segment extending from one of said stapler arms;
a blade disposed adjacent said opener segment; and
said opener segment structured to be introduced at least at a fold defined by a closure flap of an envelope until the envelope engages said blade and is cut thereby.
